(19) United States
(12) Patent Application Publication
(10) Pub. No.: US 2002/0043597 A1
(43) Pub. Date: Apr. 18, 2002

(54) Rotation-preventing device

(75) Inventor: Matts Forsberg, Morrum (SE)

Correspondence Address: BROWDY AND NEIMARK, P.L.L.C., 624 NINTH STREET, NW, SUITE 300, WASHINGTON, DC, 20001-5303, US

(73) Assignee: SVENSKA KENAB KARLSHAMNS ERGONOMI AB,, BRAKNE-HOBT (SE)

(21) Appl. No.: 09/978,682

(22) Filed: Oct. 18, 2001

(30) Foreign Application Priority Data
Oct. 18, 2000 (SE) 0003762-2

(51) Int. Cl. A45F 3/44; F16M 11/20

(52) U.S. Cl. 248/188.8; 248/156

(57) ABSTRACT

A longitudinally adjustable leg assembly comprises a holder (11, 8) which is adapted to be fixed to the underside of a table top (1), and first, second and third elongate carrier elements (2, 3, 4). These cooperate by threaded engagement and are telescopingly displaceable inside each other. One of the first and third carrier elements (2, 4) is along essentially its entire length enclosed by and mounted rotatably but axially immovably in the holder (11, 8), and the other of the first and third carrier elements (4, 2) is arranged non-rotatably relative to the holder (11, 8). The leg assembly has a means for preventing rotation of the other of the first and third carrier elements (4, 2). Said means extends along the entire second carrier element (3), the rotation-preventing means and the holder (11, 8) and respectively the other of the first and third carrier elements (4, 2) having engaging means in the form of grooves (21, 22) and projections (24, 25) engaging therein and arranged between the rotation-preventing means and the holder (11, 8) and respectively between the rotation-preventing means and the other of the first and third carrier elements (4, 2).

### FIELD OF THE INVENTION

The present invention relates generally to a longitudinally adjustable leg assembly, which is adapted to be fixed to the underside of a table top.

### BACKGROUND ART

Many people have work assignments which cause them to sit still all day and, for instance, work at a computer. It is therefore becoming more and more important to create a workplace that affords a good working posture, which requires that the height of the working table and work surfaces be variable.

Consequently it has become more and more common to have vertically adjustable tables which can be adjusted so that the working posture will be as good as possible and moreover make it possible for several people to share the workplace. Vertically adjustable tables which make it possible to vary the user's working posture between sitting and standing result in an additional improvement of the workplace since a varied working posture wears less on the user's body.

Ordinary vertically adjustable tables have longitudinally adjustable legs which consist of two telescopic elements, which are in threaded engagement and are slid inside each other by turning of one element relative to the other. However, this causes restrictions to the degree at which the height of the table can be varied. The table cannot be raised higher than the total length of the telescopic elements or be lowered lower than the length of the longest element. A leg with two telescopic elements therefore does not provide a sufficient range of maximum and minimum heights of the table. It will therefore be necessary to have more than two telescopic elements if a greater range is to be achieved, so that for instance the table can be used in both a sitting and a standing work posture.

For legs with two telescopic elements, it does not constitute a problem to turn one element relative to the other. One element can be fixed to the table while the other is turned. Legs with three telescopic elements, however, cause problems with the solution of turning the elements relative to each other. If turning of one element takes place, it is necessary to prevent, by means of some kind of turn lock, the other elements from being turned along but instead they must be displaced on the thread of the turning element. When the leg has three telescopic elements, the outermost element is extended, in the highest position of the table, so far as to not to be in contact with the part which is axially immovable relative to the table top. This means that the outermost element cannot be directly non-rotationally attached to the table top.

U.S. Pat. No. 5,282,593 suggests a method of preventing rotation of the outermost element when the leg has three telescopic elements. A rotation-preventing mechanism is thus arranged inside the telescopic elements and consists of a telescopic device. When the elements are extended, the telescopic rotation-preventing mechanism comes along and can thus prevent rotation of the outermost element. This is a complicated device with two telescopic mechanisms which are to function simultaneously.

If the outer tubes of the leg are of a cross-section that prevents them from rotating in each other, a turn lock is provided by these outer tubes being connected to the telescopic elements, which is shown in FR 2,747,280. Such a solution, however, means that the outer tubes engage each other along the entire circumference of the outer tubes. This causes large surfaces which engage each other and great friction that must be overcome also when these tubes are to move axially relative to each other. Furthermore the possibility of selecting the outer appearance of the tube is limited since the cross-section of the outer tubes must be such that the tubes cannot rotate in each other. Consequently, a leg whose outer cross-section is round could not be used since round tubes can be rotated in each other.

### SUMMARY OF THE INVENTION

An object of the invention is to provide a longitudinally adjustable leg for a table or some other piece of furniture with at least three telescopic carrier elements for adjustment of the length. A further object of the invention is to provide a simple construction for preventing the element which is furthest away from the table top from being rotated. A specific object of the invention is to provide a rotation-preventing construction which can be applied to legs of any cross-section.

The objects of the invention are achieved by a longitudinally adjustable leg assembly according to claim 1 and by means of a rotation-preventing device according to claim 8. Preferred embodiments are stated in the dependent claims 2-7.

The objects of the invention are thus achieved by a longitudinally adjustable leg assembly comprising a holder which is adapted to be fixed to the underside of a table top, and first, second and third elongate carrier elements. These elongate carrier elements cooperate by threaded engagement and are directed away from the holder. They are further telescopingly displaceable relative to each other with the second carrier element between the first and the third carrier element. One of the first and third carrier elements is along essentially its entire length enclosed by and mounted rotatably but axially immovably in the holder and the other of the first and third carrier elements is arranged non-rotatably relative to the holder. The first carrier element has an external thread and an expanded portion at an end located inside the second carrier element. The second carrier element is a tube with an external thread, with an internal thread portion at an end enclosing the first carrier element, in threaded engagement with the external thread of the first carrier element, and with an expanded portion at an end located inside the third carrier element. The third carrier element consists of a tubular element with an internal thread portion at an end enclosing the second carrier element, in threaded engagement with the external thread of the second carrier element. The longitudinally adjustable leg assembly further comprises means for rotating the carrier element mounted in the holder and a means for preventing rotation of the other of the first and third carrier elements, said rotation-preventing means extending along the entire second carrier element. The rotation-preventing means and the holder and respectively the other of the first and third carrier elements have engaging means in the form of grooves and projections engaging therein and arranged between the rotation-preventing means and the holder and respectively between the rotation-preventing means and the other of the first and third carrier elements.

A longitudinally adjustable leg assembly of this kind can thus have any outer form. The arrangement of the rotation-preventing means implies that the outer tubes are not used for preventing rotation and, consequently, their appearance is not limited to their having have a rotation-preventing function. Moreover the engaging means in the form of projections engaging in grooves mean that the rotation-preventing function is achieved over a limited surface. Owing to the projections and grooves, the rotation-preventing means is not in contact with the holder and the other of the first and third carrier elements along the entire overlapping length, which means that the same friction is achieved all the time. Otherwise there will be a larger rotation-preventing surface the more the carrier elements are inserted into each other.

According to a preferred embodiment, the rotation-preventing means has the grooves and the holder and the other of the first and third carrier elements have the projections.

This means that only projections must be arranged on the carrier element and the holder, the appearance of which is also controlled by other functional meanings. Thus the rotation-preventing means can be adjusted to the location of the projections.

Preferably the rotation-preventing means has a profiled tube comprising the grooves and arranged on the outside of the other carrier element.

If the grooves are formed in a tube, the stability in the rotation-preventing means will be improved. This means that the rotation-preventing means cannot in any way be inclined relative to the axis of the leg, which would otherwise allow a certain degree of rotation and instability.

The other carrier element is suitably mounted rotatably but axially essentially immovably in the profiled tube.

This design means that the tube follows the motions of the other carrier element and, thus, no other telescopic mechanism is required to prevent rotation. Since the rotation-preventing means follows the axial motion of the other carrier element, the means need not be extensible and can therefore have a simple and thus inexpensive design.

The projections of the holder are advantageously arranged on a turn lock which is fixed to the lower end of the holder.

This means that the rotation-preventing means can be in contact with the projections of the holder even if it is moved to the lower end of the holder.

The other of the first and third carrier elements has preferably projections in the form of a lug at its upper end closest to the holder.

As a result, the carrier element can be in contact with the rotation-preventing means even if it is moved out in the longest position of the leg.

In a preferred embodiment, the leg assembly has first, second and third outer tubes, which are telescopingly displaceable relative to each other, follow the relative motion of the three carrier elements and are circular in cross-section, the first outer tube constituting part of the holder.

Owing to this arrangement a rotation-preventing means must be arranged in the leg assembly since round tubes can be turned in each other.

The objects of the invention are also achieved by a rotation-preventing device for a longitudinally adjustable leg assembly, said leg assembly having a holder which is adapted to be fixed to the underside of a table top. The leg assembly further has first, second and third carrier elements which cooperate by threaded engagement and are telescopically displaceable inside each other with the second carrier element between the first and the third carrier element and with the first element mounted rotatably but axially immovably in the holder. The rotation-preventing device is adapted to prevent rotation of the third carrier element relative to the holder and extends along the entire extent of the second carrier element. The rotation-preventing device and the holder and respectively the third carrier element have engaging means in the form of grooves and projections engaging therein between the rotation-preventing device and the holder and respectively between the rotation-preventing device and the third carrier element.

### BRIEF DESCRIPTION OF THE DRAWINGS

A currently preferred embodiment of the invention will now be described by way of example and with reference to the accompanying drawings.

FIG. 1 is an exploded view showing a leg assembly according to the invention with its components.

FIG. 2 shows the leg assembly in FIG. 1 as assembled and in cross-section.

FIG. 3 is a cross-sectional view of the leg assembly taken along line III-III in FIG. 2.

### DETAILED DESCRIPTION OF A PREFERRED EMBODIMENT

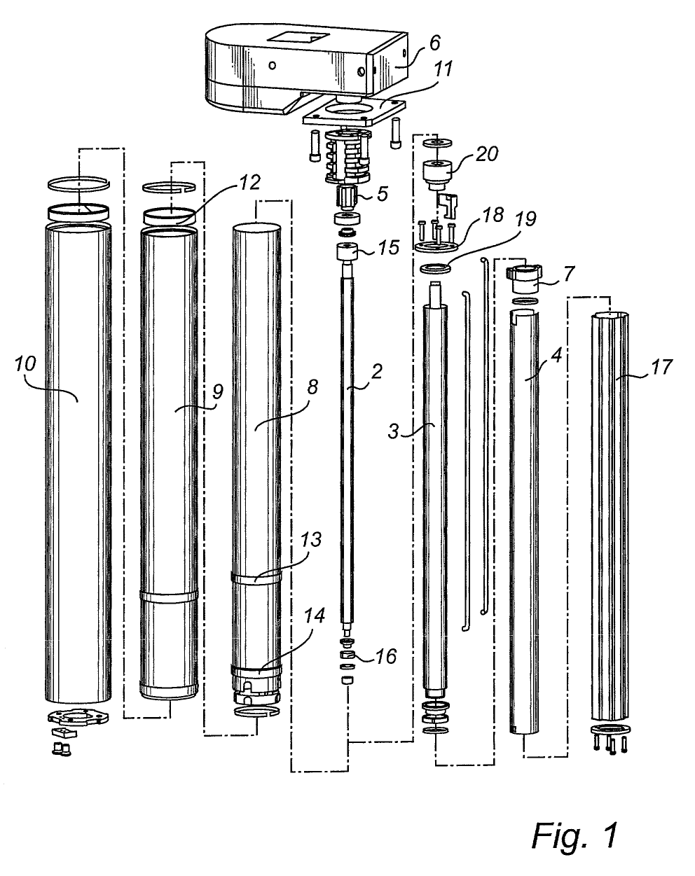

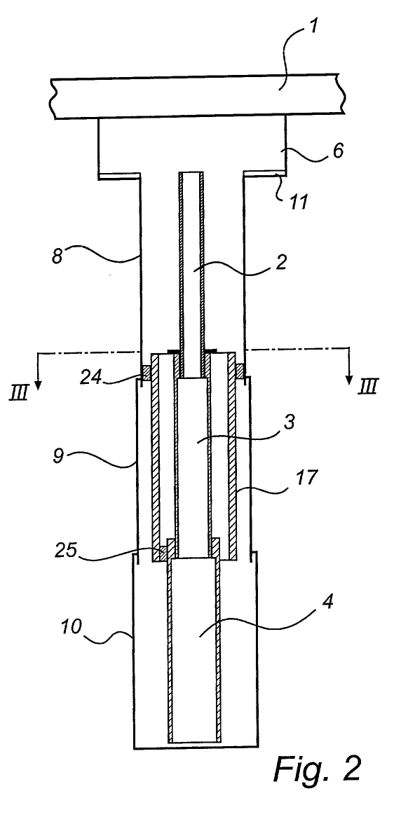

FIGS. 1 and 2 show a leg assembly according to the invention. The leg assembly is in FIG. 1 divided so that its essential components are shown spaced apart. FIG. 2 shows the leg assembly in cross-section in a position immediately adjacent to the position of the leg assembly of maximum length.

The leg assembly is adapted to be fixed to the underside of a table top 1 or the like, which is to be raised and lowered, as desired. The leg assembly comprises a first, a second and a third elongate carrier element 2, 3, 4. The three carrier elements 2, 3, 4 extend away from the table top 1 and are telescopingly displaceable in relation to each other, which makes it possible to vary the length of the leg assembly.

The first carrier element 2 has an external thread along its entire extent. The first carrier element 2 is at its end closest to the table top 1 non-rotationally connected with a driver 5. The driver 5 is caused to rotate by an electric motor in a motor casing 6, which is fixed to the underside of the table top 1. The first carrier element 2 thus rotates when the electric motor causes the driver 5 to rotate, but does not move axially.

The second carrier element 3 consists of a tube. An upper portion of the tube 3 has an internal thread which is in threaded engagement with the external thread of the first carrier element 2. When the first carrier element 2 is caused to rotate by the motor via the driver 5, the second carrier element 3 is moved axially in relation to the first carrier element 2 by the portion of the second carrier element 3 with an internal thread being moved on the external thread of the first carrier element 2. The second carrier element 3 has an external thread along its entire extent.

Also the third carrier element 4 consists of a tube. The third carrier element 4 has an upper portion with an internal thread for threaded engagement with the external thread of the second carrier element 3. The upper portion of the third carrier element 4 comprises a nut 7 which is non-rotationally arranged in the third carrier element 4. When the second carrier element 3 is rotated, the third carrier element 4 is thus moved axially in relation to the second carrier element 3 by the nut 7 being moved on the external thread of the second carrier element 3.

The leg assembly has on its outside tubes which conceal the entire inner structure. As a result, the leg assembly, as its length is changed all the time, has an outer casing without sharp edges. More specifically, the leg assembly has three tubes 8, 9, 10 which are axially displaceable relative to each other. The axial displacement of the tubes 8, 9, 10 follows the axial displacement of the carrier elements 2, 3, 4 relative to each other. The innermost tube 8 is fixedly connected, e.g. welded, to a plate 11. When the table top 1 is raised, the innermost tube 8 thus comes along. The plate 11 and the innermost tube 8 consequently form a holder for the leg assembly. The outermost tube 10 is fixed to the third carrier element 4 and therefore follows the motion thereof in relation to the other carrier elements 2, 3. The intermediate tube 9 has an internal guide ring 12 and the innermost tube 9 has two external guide rings 13, 14. The three guide rings 12, 13, 14 ensure the sliding of the intermediate tube 9 on the innermost tube 8 and prevent the intermediate tube 9 from sliding off the innermost tube 8 during the displacement of the leg.

The first carrier element 2 has expanded portions 15, 16 at both ends. These upper and lower expanded portions 15, 16 prevent the second carrier element 3 from being disengaged from the first carrier element 2. When the second carrier element 3 abuts against the lower expanded portion 16 of the first carrier element 2, it rotates together with the first carrier element 2. This rotation causes the third carrier element 4 to be moved axially on the second carrier element 3.

The second carrier element 3 is rotatably mounted in a profiled tube 17. A washer 18 is fixed to the upper end of the profiled tube 17. Axial motion of the second carrier element 3 relative to the profiled tube 17 is prevented by a washer 19 and a nut 20 which are fixed to the second carrier element 3 one on each side of the profiled tube 17. The washer 19 and the nut 20 have a larger radius than the hole in the washer 18 and therefore can not be moved relative to the washer 18 and the profiled tube 17. The profiled tube 17 extends along essentially the length extent of the second carrier element 3 and constitutes of part of a rotation-preventing means for the third carrier element 4.

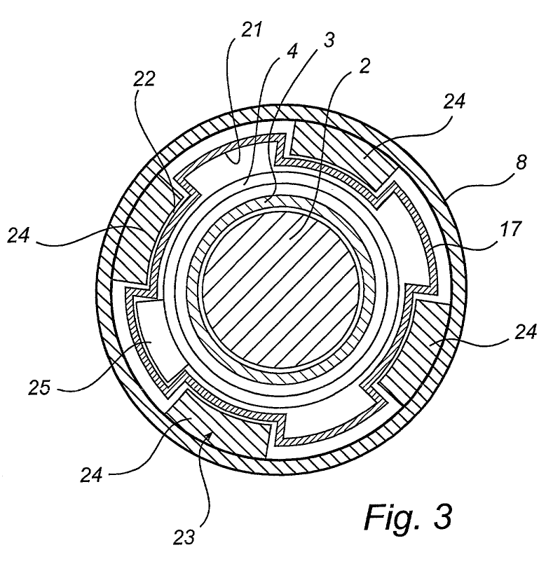

Reference is now made to FIG. 3, which is a cross-section of the leg assembly. The profiled tube 17 is non-rotationally mounted on both the innermost of the outer tubes 8 of the leg assembly and the third carrier element 4. The profiled tube 17 thus ensures that the third carrier element 4 is non-rotational relative to the innermost tube 8 which is fixed to the table top 1. The profiled tube 17 has internal grooves 21 and external grooves 22 along its entire extent. A turn lock 23 is fixed to the lower end of the innermost tube 8. The turn lock 23 has projections 24 which engage in the outer grooves 22 of the profiled tube and thus prevent rotation of the profiled tube 17 relative to the third carrier element 4.

The third carrier element 4 has at its upper end at least one outer projection 25 in the form of a lug. The projection 25 engages in one of the inner grooves 21 and thus prevents rotation of the third carrier element 4 relative to the profiled tube 17 and via the engagement between the outer grooves 22 of the profiled tube 17 and the projections 24 also relative to the innermost tube 8.

According to an alternative embodiment (not shown), the grooves could be arranged in the innermost tube and the third carrier element. The profiled tube would then have inner and outer projections that would engage in the groove in the third carrier element and respectively in the groove in the innermost tube.

As the length of the leg assembly is being changed, the profiled tube 17 follows the axial motion of the second carrier element 3. As a result, the profiled tube 17 can in all the positions of the leg assembly be in contact with the innermost tube 8 as well as the third carrier element 4 without the profiled tube 17 having to be longer than one of the carrier elements 2, 3, 4. The projections 24 of the innermost tube 8 engage all the time in a portion of the outer grooves 22 of the profiled tube 17. The projections 24 of the innermost tube 8 are arranged at the lower end of the tube 8, so that the projections 24 engage in the profiled tube 17 at its lower end when the leg assembly is in its shortest position, and at the upper end of the profiled tube 17 when the leg assembly is in its longest position. When the second carrier element 3 rotates, the third carrier element 4 is moved axially relative to the second carrier element 3 as well as the profiled tube 17. The projection 25 of the third carrier element 4 is then moved in the internal grooves 21 of the profiled tube 17, but is all the time in engagement with the profiled tube 17. The projection 25 of the third carrier element 4 is arranged at the upper end of the carrier element 4, so that the projection 25 engages in the profiled tube 17 at its upper end when the leg assembly is in its shortest position and at the lower end of the profiled tube 17 when the leg assembly is in its longest position.

It will be appreciated that a great number of modifications of the embodiment described above are feasible within the scope of the invention as defined by the appended claims. For instance, the first carrier element closest to the holder could be a tube with an internal thread, and the second and third carrier elements could be telescopingly displaceable inside the first carrier element.

1. A longitudinally adjustable leg assembly, comprising a holder which is adapted to be fixed to the underside of a table top; first, second and third elongate carrier elements which cooperate by threaded engagement and which are directed away from the holder and are telescopically displaceable relative to each other with the second carrier element between the first and third carrier elements, one of the first and third carrier elements being along essentially their entire length enclosed by and mounted rotatably but axially immovably in the holder and the other of the first and third carrier elements being arranged non-rotatably relative to the holder, the first carrier element having an external thread and an expanded portion at an end located inside the second carrier element, the second carrier element being a tube with an external thread, with an internal thread portion at an end enclosing the first carrier element, in threaded engagement with the external thread of the first carrier element, and with an expanded portion at an end located inside the third carrier element, the third carrier element consisting of a tubular element with an internal thread portion at an end enclosing the second carrier element, in threaded engagement with the external thread of the second carrier element; and means for rotating the carrier element mounted in the holder, characterised by a means for preventing rotation of the other of the first and third carrier elements, said rotation-preventing means extending along the entire second carrier element, the rotation-preventing means and the holder and respectively the other of the first and third carrier elements having engaging means in the form of grooves and projections engaging therein and arranged between the rotation-preventing means and the holder and respectively between the rotation-preventing means and the other of the first and third carrier elements.

2. A longitudinally adjustable leg assembly as claimed in claim 1, in which the rotation-preventing means has the grooves and the holder and the other of the first and third carrier elements have the projections.

3. A longitudinally adjustable leg assembly as claimed in claim 2, in which the rotation-preventing means has a profiled tube comprising the grooves and arranged on the outside of the other carrier element.

4. A longitudinally adjustable leg assembly as claimed in claim 3, in which the other carrier element is mounted rotatably but axially essentially immovably in the profiled tube.

5. A longitudinally adjustable leg assembly as claimed in any one of claims 2-4, in which the projections of the holder are arranged on a turn lock which is fixed to the lower end of the holder.

6. A longitudinally adjustable leg assembly as claimed in any one of claims 2-5, in which the other of the first and third carrier elements has a projection in the form of a lug at its upper end closest to the holder.

7. A longitudinally adjustable leg assembly as claimed in any one of the preceding claims, in which the leg assembly has first, second and third outer tubes which are telescopically displaceable relative to each other, follow the relative motion of the three carrier elements and are circular in cross-section, the first outer tube constituting part of the holder.

8. A rotation-preventing device for a longitudinally adjustable leg assembly, said leg assembly having a holder which is adapted to be fixed to the underside of a table top, and first, second and third carrier elements which cooperate by threaded engagement and are telescopically displaceable inside each other with the second carrier element between the first and the third carrier element and with the first element mounted rotatably but axially immovably in the holder, characterised in that the rotation-preventing device is adapted to prevent rotation of the third carrier element relative to the holder, that the rotation-preventing device extends along the entire extent of the second carrier element, and that the rotation-preventing device and the holder and respectively the third carrier element have engaging means in the form of grooves and projections engaging therein between the rotation-preventing device and the holder and respectively between the rotation-preventing device and the third carrier element.
